(19) United States
(12) Patent Application Publication
(10) Pub. No.: US 2010/0067860 A1
(43) Pub. Date: Mar. 18, 2010

(54) RARE EARTH-DOPED CORE OPTICAL FIBER

(75) Inventors: Masashi IKEDA, Sakura-shi (JP); Naritoshi YAMADA, Sakura-shi (JP); Kuniharu HIMENO, Sakura-shi (JP); Michihiro NAKAI, Sakura-shi (JP); Tomoharu KITABAYASHI, Sakura-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJIKURA LTD., Tokyo (JP)

(21) Appl. No.: 12/604,913

(22) Filed: Oct. 23, 2009

Related U.S. Application Data
(63) Continuation of application No. PCT/JP2008/057734, filed on Apr. 22, 2008.

(30) Foreign Application Priority Data
Apr. 25, 2007 (JP) 2007-115492

(51) Int. Cl. G02B 6/02; G02B 6/00

(52) U.S. Cl. 385/127; 385/142

(57) ABSTRACT

A rare earth-doped core optical fiber includes a core comprising a silica glass containing at least aluminum and ytterbium, a clad provided around the core and comprising a silica glass having a lower refraction index than that of the core, and a polymer layer provided on the outer circumference of the clad and having a lower refractive index than that of the clad, wherein aluminum and ytterbium are doped into the core such that a loss increase by photodarkening, T_{PD}, satisfies the following inequality (A). By this rare earth-doped core optical fiber, it is possible to manufacture an optical fiber laser capable of maintaining a sufficient laser oscillation output even when used for a long period of time.

T_{PD}≧10^{{-0.655*(D}^{_{Al}}^{)-4.304*exp{-0.00343*(A}^{_{Yb}}^{)}+1.274}} (A)

### TECHNICAL FIELD

The present invention relates to a rare earth-doped core optical fiber and, more particularly, a rare earth-doped core optical fiber which is used as an optical amplification fiber such as an optical fiber laser or an optical amplifier and is particularly suitable for the configuration of the optical fiber laser.

This application is a continuation application based on a PCT Patent Application No. PCT/JP2008/057734, filed Apr. 22, 2008, whose priority is claimed on Japanese Patent Application No. 2007-115492 filed Apr. 25, 2007, the entire content of which are hereby incorporated by reference.

### BACKGROUND ART

Recently, it has been reported that a single-mode optical fiber laser or optical amplifier, which employs an optical fiber doped with a rare earth element such as neodymium (Nd), erbium (Er), praseodymium (Pr), and ytterbium (Yb), as a laser active medium (hereinafter referred to as a rare earth doped optical fiber) has many possible applications in widefields such as optical sensing or optical communication, and their applicability has been expected. One example of applications thereof is an Yb-doped core optical fiber laser employing an optical fiber in which a core is doped with Yb (which is hereinafter referred to as a Yb-doped core optical fiber), which is examined for the use in marker, repairing, soldering, cutting/drilling, welding for various Materials or the like, and then commercialized. Conventionally, the laser used in such material processing applications has been mainly a YAG laser, but recently the requirements for the processing performance have become more stringent, and as a result, the needs of laser performance have increased. For example,

1. a smaller spot size is required in order to achieve high precision processing;

2. a higher output power is required; and

3. a reduction in down time for maintenance, etc. of a laser (such as MTBF, and MTBM) is required.

For these requirements, the Yb-doped core optical fiber laser is characterized in that it has

1. a spot size in a μm-order;

2. a several W through several kW output power; and

3. an expected life time of 30,000 or more, and the Yb-doped core optical fiber laser has a greater advantage when compared to a conventional YAG laser.

As the rare earth-doped core optical fiber, there is generally known an optical fiber obtained by using a rare earth-doped glass, as described in Patent Documents 1 and 2. The rare earth-doped glass is doped with a rare earth element, aluminum, and fluorine in a host glass comprising a SiO₂-based composition, and the rare earth-doped core optical fiber includes the glass as a core. Accordingly, the core part is doped with a rare earth element, aluminum, and fluorine.

If a rare earth element of about 0.1% by mass or more is doped in a SiO₂ glass or a GEO₂—SiO₂-based glass used in a general optical fiber, there is a disadvantage that so-called concentration quenching occurs.

This is a phenomenon in which the energy of electrons excited by agglomerating (clustering) rare earth ions in the glass is apt to be lost in a non-radioactive process, and light emission characteristics such as the life time or efficiency of light emission is damaged. By doping both the rare earth element and Al, since a high-concentration rare earth element can be doped without damaging the light emission characteristics and a sufficient amplification gain can be obtained even when the length of action with the pump light is shortened, miniaturization of the laser or the optical amplifier can be realized in Patent document 1.

Patent Document 2 describes a method for manufacturing a rare earth-doped core optical fiber, and in particular a rare earth-doped glass. In this method, a preform of a silica porous glass having an open pore connected therewith is immersed in a solution containing a rare earth ion and an aluminum ion, and the rare earth element and the aluminum are impregnated in the preform. Thereafter, a drying process is carried out, in which the preform is dried, the chloride of the rare earth element and the aluminum are deposited in the pores of the preform, and the deposited chloride is oxidized and stabilized. Then, the preform after the drying process is sintered for vitrification. Further, at a time between the completion of the drying process and the sintering process, the preform is subject to heat treatment under an atmosphere containing fluorine to dope the fluorine.

A rare earth-doped core optical fiber is obtained by synthesizing glass, as a clad portion, around the obtained rare earth-doped glass to obtain a glass preform for manufacturing of an optical fiber; and then fiber-drawing the preform. Herein, in order to obtain an optical fiber that is used for an Yb-doped core optical fiber laser, ytterbium (Yb) may be used as a rare earth element in the manufacturing process for the rare earth-doped glass.

An example of other methods for manufacturing an Yb-doped core optical fiber is a combination of a MCVD process and a solution process, as described in Non-Patent Document 1. In this method, SiCl₄, GeCl₄, O₂ gases, etc. are firstly flowed through a silica glass tube which is to be served as a clad glass, and a heat source such as an oxyhydrogen burner disposed outside the silica glass tube is used to oxidize SiCl₄ and GeCl₄ and to produce SiO₂ and GeO₂ glass soots, which are then deposited inside the silica glass tube. At this time, the temperature during deposition is kept to not give a completely transparent glass, thus obtaining a glass in a porous state. Next, a solution containing Yb ions is introduced into the inside of the silica glass tube having the prepared porous glass layer therein, and penetrated into the porous portion. After the sufficient penetration time with the solution, the solution is withdrawn from the silica glass tube, and the tube is dehydrated to remove water under a chlorine atmosphere.

Then, the porous portion is made transparent, and core solidification is performed to prepare a preform for a Yb-doped core optical fiber. If necessary, the Yb-doped core optical fiber is obtained by synthesizing a glass, as a clad portion, around the prepared preform, thereby giving a transparent glass preform for preparation of an optical fiber; and then fiber-drawing the preform. Further, the obtained optical fiber can be used to constitute an Yb-doped core optical fiber laser.

FIG. 1 is a configuration diagram showing one example of the Yb-doped core optical fiber laser, in which the Yb-doped core optical fiber laser has a constitution comprising a Yb-doped core optical fiber 1, LD 2 as a pump light source connected to input the pump light from one end of the fiber, and fiber gratings 3 and 4 connected to both ends of the Yb-doped core optical fiber 1.

[Patent Document 1] Japanese Unexamined patent Application, First Publication No. 11-314935

[Patent Document 2] Japanese Unexamined Patent Application, First Publication No. 3-265537

[Non-Patent Document 1] Edited by Shoichi SUDO, Erbium-doped optical fiber amplifier, The Optronics Co., Ltd.

[Non-Patent Document 2] Laser Focus World Japan 2005. 8, p.p. 51-53, published by Co., Ltd. E-express

[Non-Patent Document 3] Z. Burshtein, et. al., “Impurity Local Phonon Nonradiative Quenching of Yb3+Fluorescence in Ytterbium-Doped Silicate Glasses”, IEEE Journal of Quantum Electronics, vol. 36, No. 8, Exit 2000, pp. 1000-1007

### DISCLOSURE OF THE INVENTION

### Problems to be Solved by the Invention

The present inventors have observed that when a conventional manufacturing method was used to prepare a Yb-doped core optical fiber to constitute the Yb-doped core optical fiber laser as shown in FIG. 1 to try a laser oscillation, the output power of the light at a laser oscillation wavelength of 1060 nm decreases over time, and as a result, the laser oscillation stops. Furthermore, the present inventors have also observed that this phenomenon also occurs in a commercially available Yb-doped core optical fiber from a manufacturer as an optical fiber for an optical fiber laser. For this reason, it has been proved that the conventional Yb-doped core optical fiber cannot endure over a long period of time. Non-Patent Document 2 shows that such a decrease in the output power of the laser oscillation light occurs due to a phenomenon called as ‘photodarkening’. Furthermore, it is believed that the above-described phenomenon is a phenomenon in which the output power of the laser oscillation light is decreased, due to loss by the power of the pump light and the laser oscillation light caused by photodarkening.

The photodarkening phenomenon is one that clearly differs from the above-described concentration quenching. The concentration quenching is a phenomenon in which rare earth ions are aggregated (clustered) with each other in the glass, whereby the energy of excited electrons is likely to be lost in a non-radial process. Since there is usually no change in the aggregation state of the rare earth ions during the laser oscillation, the laser oscillation, even carried out over a long period of time, does not cause the change in the degree of concentration quenching and decrease in the output power of the laser oscillation over time. Patent Documents 1 and 2 in prior art may solve the concentration quenching on an optical fiber obtained by employing a rare earth-doped glass, but they cannot solve the problems on the decrease in the output power of the laser oscillation caused from a photodarkening phenomenon.

Under these circumstances, the present invention has been made, and an object of which is to provide a rare earth-doped core optical fiber that can be used to prepare an optical fiber laser capable of maintaining a sufficient output power of laser oscillation, even carried out over a long period of time, and a manufacturing method thereof.

### Means for solving the Problem

In order to accomplish the object, the present invention provides a rare earth-doped core optical fiber, which includes a core comprising a silica glass containing at least aluminum and ytterbium, a clad provided around the core and comprising a silica glass having a lower refraction index than that of the core, and a polymer layer provided on the outer circumference of the clad and having a lower refractive index than that of the clad, wherein aluminum and ytterbium are doped into the core such that a loss increase by photodarkening, T_{PD}, satisfies the following inequality (A):

T_{PD}≧10^{{-0.655*(D}^{_{Al}}^{)-4.304*exp{-0.00343*(A}^{_{Yb}}^{)}+1.274}} (A)

[in inequality (A), TPD represents an allowable loss increase by photodarkening at a wavelength of 810 nm (unit: dB), D_{Al} represents the concentration of aluminum contained in the core (unit: % by mass), and A_{Yb} represents the peak absorption coefficient of the absorption band which appears around a wavelength of 976 nm in the absorption band by ytterbium contained in the core (unit: dB/m)].

Furthermore, the present invention provides a rare earth-doped core optical fiber, which comprises a core comprising a silica glass containing aluminum and ytterbium, a clad provided around the core and comprising a silica glass having a lower refraction index than that of the core, and a polymer layer provided on the outer circumference of the clad and having a lower refractive index than that of the clad, wherein the core has an aluminum concentration of 2% by mass or more, and ytterbium is doped into the core at such a concentration that the absorption band of ytterbium doped into the core, which appears around a wavelength of 976 nm, shows a peak absorption coefficient of 800 dB/m or less.

In the rare earth-doped core optical fiber, it is preferable that the clad is composed of an inner clad positioned on the exterior of the core, and an outer clad positioned outside the inner clad, and that the refractive index n1 of the core, the refractive index n2 of the inner clad, the refractive index n3 of the outer clad, and the refractive index n4 of the polymer layer satisfy the relationship of n1>n2>n3>n4.

In the rare earth-doped core optical fiber of the present invention, the shape of the outer circumference of the clad which is in contact with the polymer layer may be non-circular.

In the rare earth-doped core optical fiber of the present invention, the shape of the outer circumference of the clad which is in contact with the polymer layer may be one selected from a group consisting of a hexagon, a heptagon, an octagon, a nonagon, and a D-type.

In the rare earth-doped core optical fiber of the present invention, air holes may be present in a part of the clad glass.

In the rare earth-doped core optical fiber of the present invention, the core may contain fluorine.

### ADVANTAGE OF THE INVENTION

A rare earth-doped core optical fiber of the present invention includes a core formed of a silica glass including at least aluminum and ytterbium, a clad provided around the core and formed of a silica glass having a lower refractive index than that of the core, and a polymer layer provided on the outer circumference of the clad and having a lower refractive index than that of the clad. Aluminum and ytterbium are doped to the core such that a photodarkening loss increase amount T_{PD} satisfies inequality (A). As a result if the rare earth-doped core optical fiber of the present invention is used as an optical fiber laser using a rare earth element as a laser active medium, since the output of light having a laser oscillation wavelength is not attenuated even when laser oscillation is performed for a long time, it is possible to manufacture an optical fiber laser capable of maintaining a sufficient output power of laser oscillation even when used for a long period of time.

### BRIEF DESCRIPTION OF THE DRAWINGS

FIG. 1 is a schematic view showing an example of the configuration of an optical fiber laser.

FIG. 2 is a schematic cross sectional view of a rare earth-doped core optical fiber according to a first embodiment of the present invention.

FIG. 3 is a graph showing a absorption spectrum by Yb of an Yb-doped core optical fiber of the present invention.

FIG. 4 is a schematic cross sectional view of a rare earth-doped core optical fiber according to a second embodiment of the present invention.

FIG. 5A is a schematic cross sectional view showing an example of a rare earth-doped core optical fiber according to a third embodiment of the present invention.

FIG. 5B is a schematic cross sectional view showing an example of a rare earth-doped core optical fiber according to a third embodiment of the present invention.

FIG. 5C is a schematic cross sectional view showing an example of a rare earth-doped core optical fiber according to a third embodiment of the present invention.

FIG. 5D is a schematic cross sectional view showing an example of a rare earth-doped core optical fiber according to a third embodiment of the present invention.

FIG. 5E is a schematic cross sectional view showing an example of a rare earth-doped core optical fiber according to a third embodiment of the present invention.

FIG. 6A is a schematic cross sectional view showing an example of a rare earth-doped core optical fiber according to a third embodiment of the present invention.

FIG. 6B is a schematic cross sectional view showing an example of a rare earth-doped core optical fiber according to a third embodiment of the present invention.

FIG. 6C is a schematic cross sectional view showing an example of a rare earth-doped core optical fiber according to a third embodiment of the present invention.

FIG. 6D is a schematic cross sectional view showing an example of a rare earth-doped core optical fiber according to a third embodiment of the present invention.

FIG. 6E is a schematic cross sectional view showing an example of a rare earth-doped core optical fiber according to a third embodiment of the present invention.

FIG. 7 is a schematic view showing the propagation of light when pump light is incident to a clad which is axially symmetrical.

FIG. 8A is a schematic cross sectional view showing an example of the structure in which air holes are provided in a portion of a clad in a rare earth-doped core optical fiber of the present invention.

FIG. 8B is a schematic cross sectional view showing an example of the structure in which air holes are provided in a portion of a clad in a rare earth-doped core optical fiber of the present invention.

FIG. 9 is a schematic cross sectional view showing a rare earth-doped core optical fiber according to Example 1 of the present invention.

FIG. 10 is a block diagram showing the measurement sequence for measuring the loss increase by photodarkening used in the Examples.

FIG. 11A is a graph showing the results of the loss increase by photodarkening as measured in Example 1 of the present invention.

FIG. 11B is a graph showing the result of the loss increase by photodarkening as measured in Example 1 of the present invention.

FIG. 12 is a configuration diagram showing an optical fiber laser used in Example 1 of the present invention.

FIG. 13 is a graph showing a variation of laser oscillation output power of the optical fiber laser measured in Example 1 of the present invention over time.

FIG. 14 is a graph showing the results of the loss increase by photodarkening as measured in Example 2 of the present invention.

FIG. 15 is a graph showing the relationship between the loss increase by photodarkening and the Al concentration at an absorption coefficient of 800 dB/m.

FIG. 16 is a schematic cross sectional view showing a rare earth-doped core optical fiber of Example 3 of the present invention.

FIG. 17 is a configuration diagram showing an optical fiber laser used in Example 3 of the present invention.

FIG. 18 is a schematic cross sectional view showing an Yb doped core optical fiber of a comparative example.

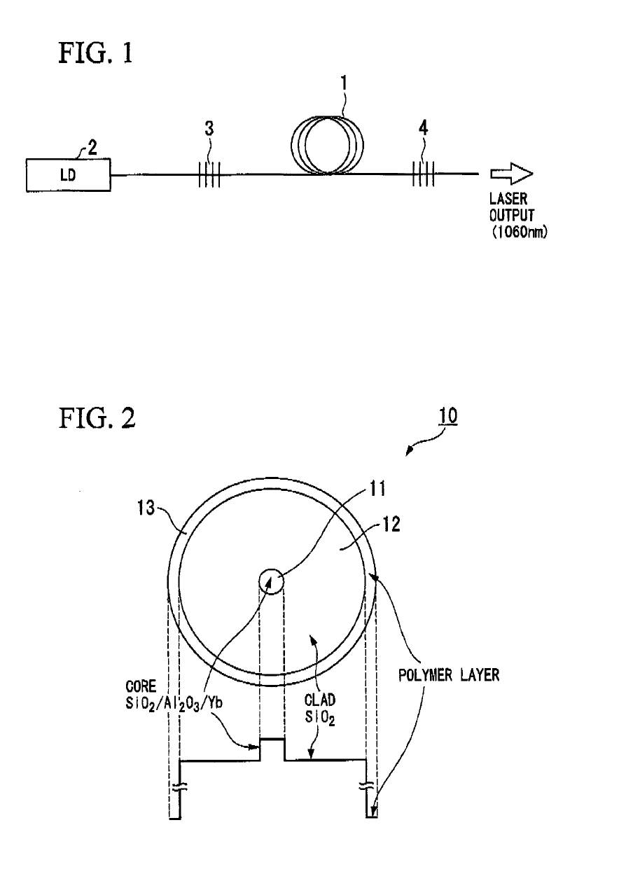

### DESCRIPTION OF REFERENCE NUMERALS AND SIGNS

1: Yb-doped core optical fiber
2: Pump light source
3,4: Optical fiber gratings
10, 20, 30, 40, 50, 60, 70: Rare earth-doped core optical fibers
11, 21, 31, 41, 51, 61, 71: Cores
12, 32, 52, 62: Clads
13, 24, 33, 44, 53, 63, 74: Polymer Layers
22, 42, 72: Inner Clads
23, 43, 73: Outer Clads
64, 75, 76: Holes

### BEST MODE FOR CARRYING OUT THE INVENTION

According to Patent Documents 1 and 2, a rare earth-doped glass having a rare earth element, aluminum, and fluorine doped in a host glass having SiO₂-based composition, and a manufacturing method thereof are disclosed, wherein ytterbium (Yb) is used as a rare earth element, and further the Yb-doped glass is used in the core portion to make an Yb-doped core optical fiber, which can be also applied in prior art. However, Patent Documents 1 and 2 have a detailed description that erbium (Er) is chosen as a rare earth element, but have no description of ytterbium being chosen as a rare earth element. Furthermore, the technology as described in Patent Documents 1 and 2 is a means for solving a problem on concentration quenching of a rare earth element, and thus it cannot be applied to solve the problem of the decrease in the output power of the laser oscillation light over time by using an Yb-doped core optical fiber (photodarkening problem) in prior art. That is, it is known that since the energy level that relates in the laser oscillation of the ytterbium ion (Yb³⁺) in the Yb-doped core optical fiber is only in two kinds of states, that is, a ²F_{7/2} ground state and a ²F_{5/2} excited state, very little concentration quenching occurs. Further, Non-Patent Document 3 describes that the ytterbium concentration upon generation of concentration quenching in the glass having neither aluminum nor fluorine doped thereinto is 5×10²⁰ cm⁻³. The Yb-doped core optical fiber used in the optical fiber laser generally has such an ytterbium concentration that the absorption band which appears around a wavelength of 976 nm shows the peak absorption coefficient in a range of from 100 to 2000 dB/m. The ytterbium concentration, as determined through calculation using these values, 0.11×10²⁰ cm⁻³ to 2.2×10²⁰ cm⁻³, which is smaller than that upon generation of concentration quenching as described in Non-Patent Document 3. Therefore, it is believed that aluminum is not needed to inhibit the concentration quenching of ytterbium.

On the other hand, a method of doping aluminum into the Yb-doped core optical fiber, as described later, can be a means for solving the problem on the decrease in the output power of the laser oscillation light, but the amount of aluminum doped is even more than that required to inhibit concentration quenching. For example, the concentration quenching was not observed in the Yb-doped core optical fiber, in which the core has a fluorine concentration of 0.6% by mass and an aluminum concentration of 0.1% by mass, and ytterbium is doped at a concentration such that the absorption band which appears around a wavelength of 976 nm in the absorption band by ytterbium contained in the core shows the peak absorption coefficient of 1000 dB/m, but remarkable increase in the photodarkening loss was observed in the fiber. Further, the fluorescence life time was measured on several other Yb-doped core optical fibers, in which the core has a fluorine concentration of 0.6% by mass and an aluminum concentration of 0.1% by mass, and the absorption coefficient is in a range of from 200 dB/m to 1900 dB/m. The results are shown in Table 1.

TABLE 1
Fluorescence life time of Yb-doped core optical fiber

| Absorption | Fluorescence |
|---|---|
| coefficient | life time |
| (dB/m) | (ms) |
| 200 | 0.8 |
| 600 | 0.8 |
| 1000 | 0.8 |
| 1400 | 0.8 |
| 1900 | 0.8 |

Regardless of the absorption coefficient, the fluorescence life time is a constant value, and accordingly, even if the absorption coefficient is in a range of from 200 dB/m to 1900 dB/m, the concentration quenching does not occur.

Patent Documents 1 and 2 as prior arts do not describe appropriate concentrations of ytterbium, aluminum, and fluorine, and thus it is difficult to solve a problem on the decrease in the output power of the laser oscillation light even using the Yb-doped core optical fiber in prior art.

Meanwhile, the rare earth-doped core optical fiber of the present invention has the following characteristics in order to solve the problem, in which the output of the laser oscillation light is degraded over time. A core formed of a silica glass including at least aluminum and ytterbium is included. A clad formed of a silica glass having a refractive index lower than that of the core is provided around the core. A polymer layer having a refractive index lower than that of the clad is provided on the outer circumference of the clad. The peak absorption coefficient of the absorption band which appears around a wavelength of 976 nm in the absorption band by ytterbium contained in the core, are adjusted, respectively, so as to obtain an allowable loss increase by photodarkening.

### FIRST EXAMPLE OF FIRST EMBODIMENT

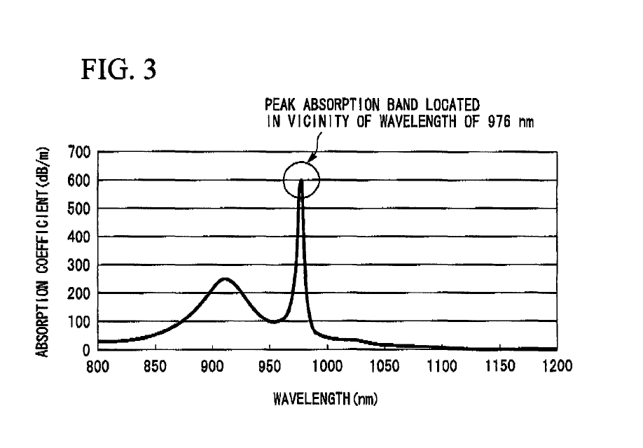

A first example of a first embodiment of a rare earth-doped core optical fiber according to the present invention will be described with reference to FIG. 2.

The rare earth-doped core optical fiber 10 of the present example includes a core 11 to which a rare earth element is doped, a clad 12 surrounding the core 11 and having a refractive index lower than that of the core 11, and a polymer layer 13 provided on the outer circumference of the clad 12 and having a refractive index lower than that of the clad 12.

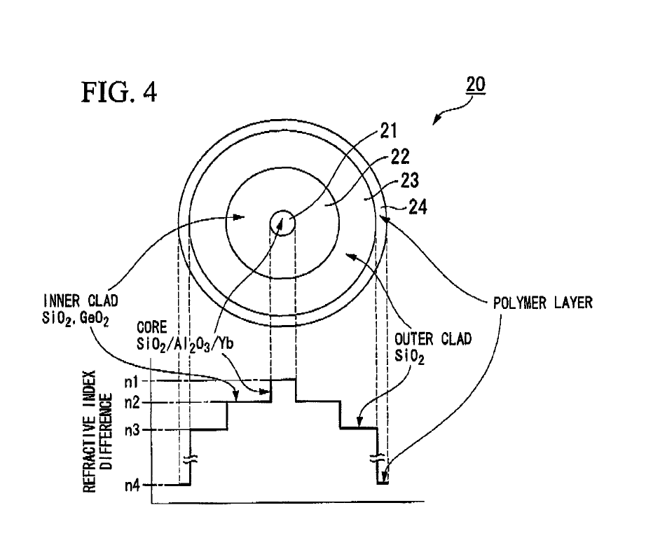

The rare earth-doped core optical fiber 10 of FIG. 2 includes the core 11 formed of a silica glass including aluminum (Al) and ytterbium (Yb) which is a rare earth element, the clad 12 formed of a silica (SiO₂) glass provided around the core 11, and the polymer layer 13 provided on the outer circumference of the clad 12 and having the refractive index lower than that of the clad 12. Furthermore, the core has an Al concentration of 2% by mass or more. In addition, Yb is contained in the core at a concentration such that the absorption band which appears around a wavelength of 976 nm shows the peak absorption coefficient 800 dB/m or less in the absorption by Yb contained in the core. FIG. 3 shows one example of the absorption spectrum by Yb of the rare earth-doped core optical fiber according to the present invention.

If an optical fiber laser is constituted by using a rare earth-doped core optical fiber having Yb doped into the core, an optical fiber laser providing an output power of a light as a laser oscillation wavelength of 1060 nm is obtained. However, an optical fiber laser using a conventional Yb-doped core optical fiber has a phenomenon that the output power of a light as a laser oscillation wavelength of 1060 nm is decreased over time, and as a result, laser oscillation stops.

On the other hand, for the optical fiber laser constituted by using the rare earth-doped core optical fiber of the present invention, the decrease rate of the output power of the light at a laser oscillation wavelength of 1060 nm can be significantly reduced even when laser oscillation is carried out over a long period of time. As the core has a higher Al concentration, the optical fiber laser has a lower decrease rate in the output power of the laser oscillation. Further, as the core has a higher Yb concentration, the optical fiber laser has a higher decrease rate in the output power of laser oscillation. As a result, by making the Al concentration of the core and the absorption coefficient by Yb of the rare earth-doped core optical fiber to suitable range described in the present invention, the decrease rate in the output power in the optical fiber laser can be significantly reduced.

By employing the structure of the present invention, it is possible to form the rare earth-doped core optical fiber of the present invention by a double clad optical fiber, and be input higher-output pump power to the clad so as to obtain higher-output laser oscillation.

In detail, when pump light is incident to the clad of the double clad optical fiber, the pump light propagates in the clad, and pump power is delivered to the rare earth element doped to the core during propagation, such that the light (signal light, beam or the like) propagating in the core may be amplified or laser-oscillated. In addition, by setting the refractive index of the polymer layer to be less than that of the silica glass, it is possible to increase the numerical aperture (NA) of the clad surrounded by the polymer layer and increase the cross sectional area of the clad. Therefore, it is possible to input the high-output pump power to the double clad optical fiber.

In the conventional rare earth-doped core optical fiber, the degradation of the laser oscillation output power becomes remarkable in the high-output pump power and thus may not be durable in the use as the double clad optical fiber. In contrast, since the rare earth-doped core optical fiber of the present invention has the core having the above-described composition and is the double clad optical fiber having the polymer layer provided on the outer circumference of the clad as described in the present embodiment, it is possible to keep high laser oscillation output power in a long period of time.

### SECOND EXAMPLE OF FIRST EMBODIMENT

A second example of the first embodiment of a rare earth-doped core optical fiber according to the present invention will be described using a detailed example.

The rare earth-doped core optical fiber of the present example has substantially the same basic structure as that of the rare earth-doped core optical fiber shown in FIG. 2, but it is a rare earth-doped core optical fiber which has the core comprising a silica glass containing aluminum (Al) and ytterbium (Yb) as a rare earth element, in which aluminum and ytterbium are doped so as to satisfy the inequality (A), taking a concentration of aluminum contained in the core as D_{Al} (unit: % by mass), and a peak absorption coefficient of the absorption band which appears around a wavelength of 976 nm in the absorption band by ytterbium contained in the core as A_{Yb} (unit: dB/m).

In the inequality (A), T_{PD} is an allowable loss increase by photodarkening at a wavelength of 810 nm in the Yb-doped core optical fiber, expressed in a unit of dB. The T_{PD} is a value as determined when an optical fiber laser is designed using the Yb-doped core optical fiber of the present invention, and is a valued determined in consideration of various factors such as an acceptable value of the decrease rate of the output power of the optical fiber laser, a use environment, an intensity of the pump light source input to the Yb-doped core optical fiber, and a desired output power of laser oscillation. If T_{PD} is set at a certain value, the loss increase by photodarkening of the Yb-doped core optical fiber of no more than T_{PD} provides the optical fiber laser using the Yb-doped core optical fiber with good characteristics. To the contrary, the loss increase by photodarkening of the Yb-doped core optical fiber of more than T_{PD} leads to unexpectedly higher decrease in the output power of the laser oscillation in the optical fiber laser using the Yb-doped core, and as a result, laser oscillation cannot be carried out over a long period of time.

From the right hand side of the inequality (A), by using two parameters: the concentration of aluminum contained in the core D_{Al} (unit: % by mass) and the peak absorption coefficient of the absorption band which appears around a wavelength of 976 nm in the absorption band by ytterbium contained in the core A_{Yb} (unit: dB/m), the loss increase by photodarkening of the Yb-doped core optical fiber can be estimated. However, the inequality (A) is an empirical inequality obtained from the data of the aluminum concentration, the absorption coefficient, and the loss increase by photodarkening of a variety of the manufactured Yb-doped core optical fibers. A process for deriving the empirical inequality will be described later.

As in the present invention, as long as the rare earth-doped core optical fiber has the concentration of aluminum contained in the core and the peak absorption coefficient of the absorption band which appears around a wavelength of 976 nm in the absorption band by ytterbium contained in the core, which are each adjusted so as to obtain an allowable loss increase by photodarkening, the optical fiber laser using the rare earth-doped core optical fiber of the present invention, even with the ytterbium concentration varying in the Yb-doped core optical fiber, has good characteristics. Particularly,

even when laser oscillation is carried out over a long period of time, most of the output power of the light at a laser oscillation wavelength is not decreased, and thus it is capable of maintaining a sufficient output power of laser oscillation, even with use over a long period of time;

even when the ytterbium concentration in the Yb-doped core optical fiber is high, decrease in the output power of the light at a laser oscillation wavelength can be maintained small;

since the ytterbium concentration in the Yb-doped core optical fiber can be set high, the length of the fiber required for laser oscillation may be shorter, and by this, reduction in cost, inhibition of generation of noise light by a non-linear optical phenomenon, and the like can be attained; and

other effects can be attained.

By employing the structure of the present invention, it is possible to configure the rare earth-doped core optical fiber of the present invention by a double clad optical fiber, and supply higher output pump power so as to obtain higher-output laser oscillation.

In detail, when pump light is incident to the clad of the double clad optical fiber, the pump light propagates in the clad, and pump power is delivered to the rare earth element doped to the core during propagation, such that the light (signal light, beam or the like) propagating in the core may be amplified or laser-oscillated. In addition, by setting the refractive index of the polymer layer to be less than that of the silica glass, it is possible to increase the numerical aperture (NA) of the clad surrounded by the polymer layer and increase the sectional area of the clad. Therefore, it is possible to supply the high output pump power to the double clad optical fiber.

In a conventional rare earth-doped core optical fiber, a higher power of the pump light leads to more remarkable decrease in the output power of the laser oscillation, and it cannot be used as the double-clad fiber. On the other hand, the rare earth-doped core optical fiber of the present invention has a core having the same composition as described above, and since is a double-clad fiber having the polymer layer 13 on the outer circumference of the clad 12D as shown in the present embodiment, it is possible to carry out laser oscillation over a long period of time.

### SECOND EMBODIMENT

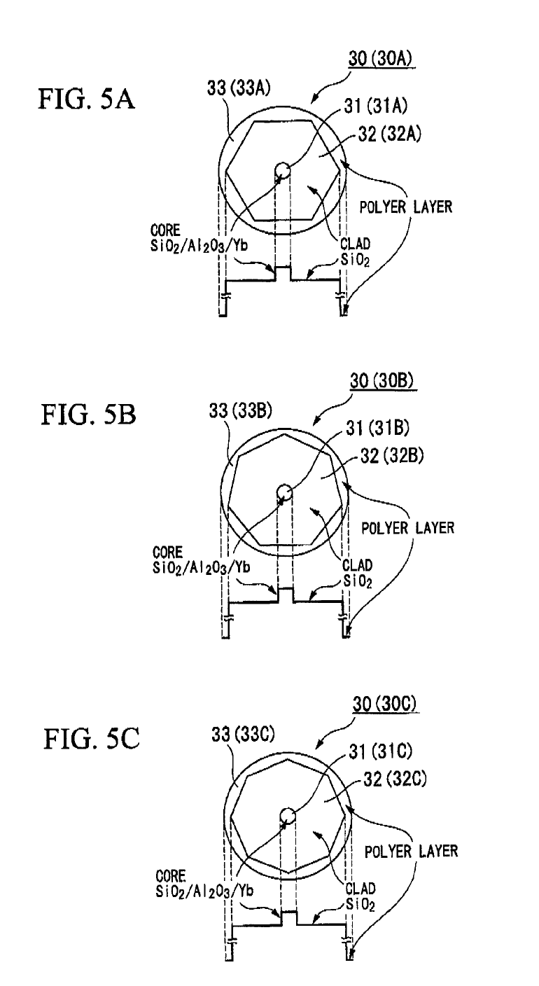

A second embodiment of a rare earth-doped core optical fiber according to the present invention will be described with reference to FIG. 4.

The rare earth-doped core optical fiber 20 of the present example includes a core 21 to which a rare earth element is doped, an inner clad 22 located in the neighborhood of the core 21, an outer clad 23 located outside the inner clad 22, and a polymer layer 24 located outside the outer clad 23.

The rare earth-doped core optical fiber 20 of FIG. 4 includes the core 21 formed of a silica glass including aluminum (Al) and ytterbium (Yb) which is a rare earth element, the inner clad 22 provided in the neighborhood of the core 21 and formed of a silica glass including germanium (Ge), the outer clad 23 provided outside the inner clad 22 and formed of a silica glass, and the polymer layer 24 provided outside the outer clad 23 and having a refractive index lower than that of the outer clad 23.

This rare earth-doped core optical fiber 20 has a structure having a refractive index satisfying the relationship among the refractive index n1 of the core 21, the refractive index n2 of the inner clad 22, the refractive index n3 of the outer clad 23, and the refractive index n4 of the polymer layer 24 of: n1>n2>n3>n4. That is, the present structure is a triple-clad structure comprising the clad composed of the inner clad 22, the outer clad 23, and the polymer layer 24.

By using such a structure, the difference in the refractive indices between the core 21 and the inner clad 22, nA (=n1−n2), can be smaller than the difference in the refractive indices between the core 21 and the outer clad 23, nB (=n1−n3). Accordingly, the effective area A_{eff} can be larger of the light at a laser oscillation wavelength of 1060 nm, and thus generation of the noise light by a non-linear optical phenomenon such as Stimulated Raman Scattering, Stimulated Brillouin Scattering, and Four Wave Mixing can be reduced. In order to increase the effective area A_{eff} by a conventional optical fiber, it is necessary to decrease the difference in the refractive indices between the core and the clad. Thus, the dopant such as Al and germanium should be reduced, but if the Al concentration is small, the decrease rate of the output power in the optical fiber laser is increased. The rare earth-doped core optical fiber 20 of the present embodiment can have the core 21 doped with a sufficient amount of Al, and the effective area A_{eff} can be further increased. Further, the optical fiber laser using the rare earth-doped core optical fiber 20 of the present embodiment can have higher performance and higher quality.

### THIRD EMBODIMENT

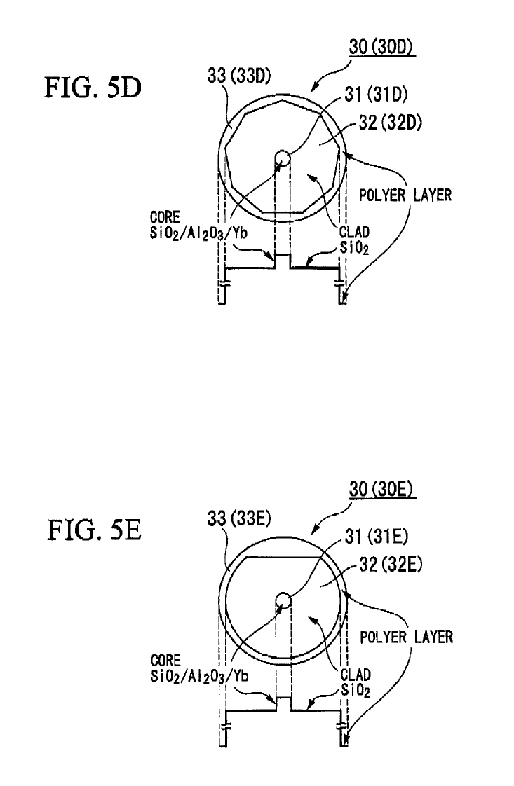

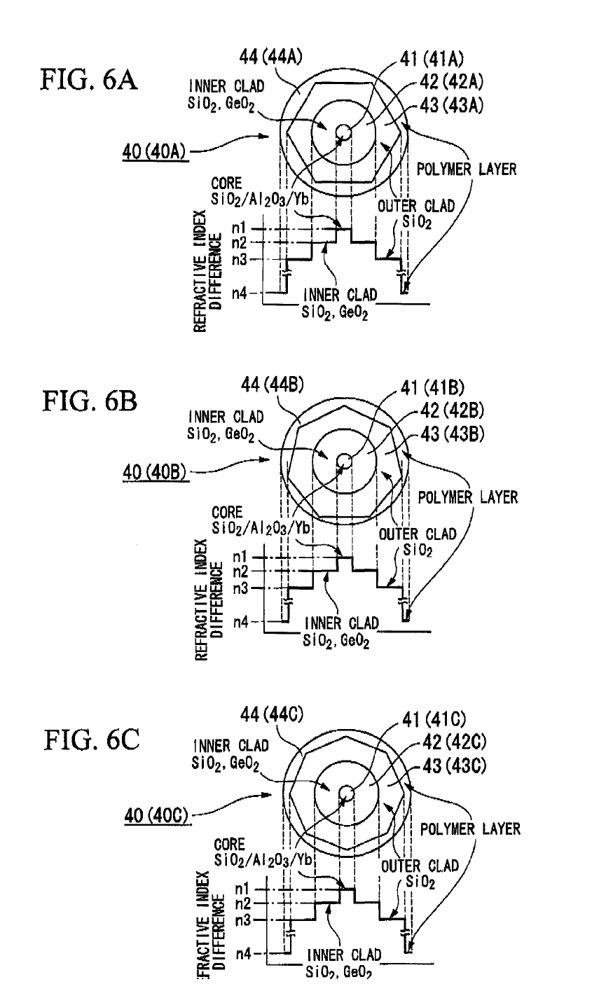

A third embodiment of a rare earth-doped core optical fiber according to the present invention will be described with reference to FIGS. 5 and 6.

The rare earth-doped core optical fiber 30 of a first example of the present embodiment includes a core 31 to which a rare earth element is doped, a clad 32 surrounding the core 31 and having a refractive index lower than that of the core 31, and a polymer layer 33 provided on the outer circumference of the clad 32 and having a refractive index lower than that of the clad 32 so as to form a double clad structure.

The rare earth-doped core optical fiber 40 of a second example of the present embodiment includes a core 41 to which a rare earth element is doped, an inner clad 42 located in the vicinity of the core 41, an outer clad 43 located outside the inner clad 42, and a polymer layer 44 located outside the outer clad 43 so as to form a triple clad structure.

In the third embodiment of the present invention, in addition to the first embodiment or the second embodiment of the present invention, the shapes of the outer circumferences of the clads 32 and 43 which are respectively in contact with the polymer layers 33 and 44 are non-circular.

In detail, for example, the shape of the clad 32A which is in contact with the polymer layer 33A as shown in FIG. 5A or the outer clad 43A which is in contact with the polymer layer 44A as shown in FIG. 6A is hexagonal, the shape of the clad 32B which is in contact with the polymer layer 33B as shown in FIG. 5B or the outer clad 43B which is in contact with the polymer layer 44B as shown in FIG. 6B is heptagonal, the shape of the clad 32C which is in contact with the polymer layer 33C as shown in FIG. 5C or the outer clad 43C which is in contact with the polymer layer 44C as shown in FIG. 6C is octagonal, the shape of the clad 32D which is in contact with the polymer layer 33D as shown in FIG. 5D or the outer clad 43D which is in contact with the polymer layer 44D as shown in FIG. 6D is nonagonal, and the shape of the clad 32E which is in contact with the polymer layer 33E as shown in FIG. 5E or the outer clad 43E which is in contact with the polymer layer 44E as shown in FIG. 6E is a D-shaped.

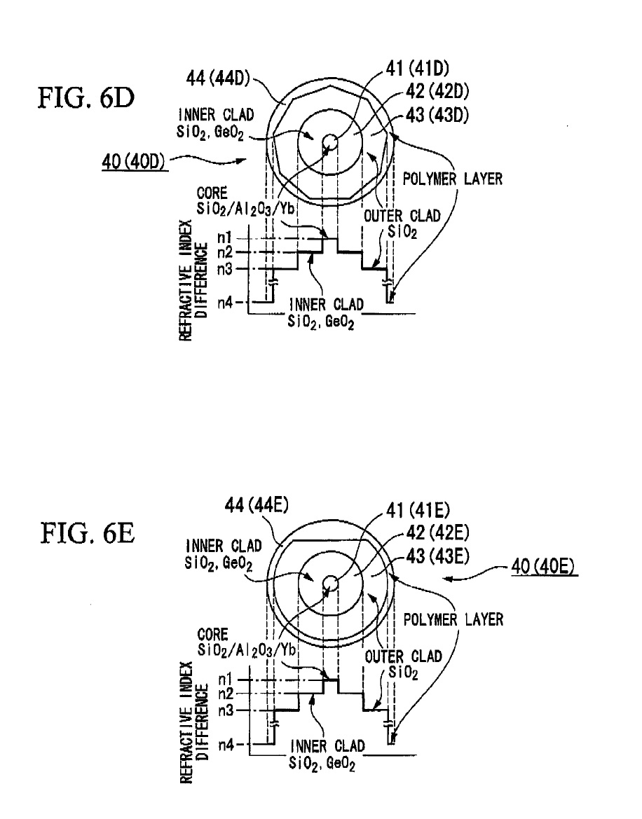

When pump light is incident to the clad of the double clad optical fiber, the pump light propagates in the clad, and pump power is delivered to the rare earth element doped to the core during propagation, such that the light (signal light, beam or the like) propagating in the core may be amplified or laser-oscillated. However, if the clad 52 is axially symmetrical as in the optical fiber 50 shown in FIG. 7, pump light incident at an angle shown in FIG. 7 reflects from the interface with the polymer layer 53 and propagates in the clad 52 while a spiral trajectory of the propagated light is being drawn at a predetermined angle so as not to be crossed to the core 51. Accordingly, an incident path of delivered pump light that is used in amplification or laser oscillation process in the core 51 is restricted and thus some of the pump light remains propagating in the clad 52.

The pump light, which is incident to the clad by setting the shape of the outer circumference of the clad which is in contact with the polymer layer to be non-circular as in the present invention, propagates in an area surrounded by the clad while forming a random trajectory in the transverse section of the optical fiber, when propagating while reflecting from the interface between the clad and the polymer layer. As a result, it is possible to increase a probability in which pump light passes through the core and improve amplification efficiency of the signal light propagating in the core.

As the result of increasing the probability in which pump light passes through the core, the pump power delivered to the core is larger. If the composition and the concentration of Yb and Al doped in the core are equal to that of the conventional rare earth-doped core optical fiber, the degradation of the laser oscillation output becomes remarkable and may not be durable in use of the double clad optical fiber. Meanwhile, since the rare earth-doped core optical fiber of the present invention has the core having the above-described composition and is the double clad optical fiber or the triple clad optical fiber having the polymer layer provided on the outer circumference of the clad as described in the present embodiment, and the shape of the outer circumference of the clad which is in contact with the polymer layer is non-circular, it is possible to increase the probability in which pump light passes through the core and improve the amplification efficiency of the signal light propagating in the core. In addition, high power laser oscillation can be kept for a long time.

In the rare earth-doped core optical fiber according to the present invention, even when air holes are provided in a part of the clad, the double-clad fiber or the triple clad optical fiber can be obtained, in which laser oscillation is carried out over a long period of time. Furthermore, by optimization of the positions of the air holes, a reduced skew light, or the like can be attained.

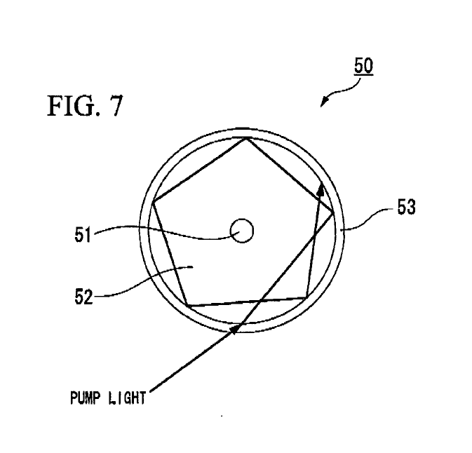

FIGS. 8A and 8B show the detailed structure of a rare earth-doped core optical fiber in which air holes are provided in a portion of a clad.

In a rare earth-doped core optical fiber 60 shown in FIG. 8A, a plurality of air holes 64, 64, . . . are provided in the portion of a clad 62.

By such a configuration, when pump light incident to the clad 62 propagates while reflecting from the interface between the clad 62 and the polymer layer 63, the pump light propagates in the clad 62 while reflecting from the interface between the air holes 64, 64, . . . provided in the clad 62 and the clad 62. Accordingly, the pump light propagates in the area surrounded by the clad 62 while forming a more random trajectory in the transverse section of the optical fiber. As a result, it is possible to increase the probability in which pump light passes through the core 61 and improve the amplification efficiency of the signal light propagating in the core 61.

Similarly, in a rare earth-doped core optical fiber 70 shown in FIG. 8B, a plurality of air holes 75, 75 . . . are provided in a portion of an inner clad 72 and a plurality of air holes 76, 76, . . . are provided in a portion of an outer clad 73.

By such a configuration, when pump light incident to the clad 73 propagates while reflecting from the interface between the outer clad 73 and the polymer layer 74, the pump light propagates in the outer clad 73 while reflecting from the interface between the air holes 76, 76, . . . provided in the outer clad 73 and the outer clad 73. Accordingly, the pump light propagates in the area surrounded by the outer clad 73 while forming a more random trajectory in the transverse section of the optical fiber. As a result, it is possible to increase the probability in which pump light passes through the core 71 and improve the amplification efficiency of the signal light propagating in the core 71.

In the rare earth-doped core optical fiber of the present invention, it is preferable that fluorine (F) is also doped to the core in addition to Yb and Al. If Al is doped to the core, the refractive index of the core is increased if the concentration of Al is high and thus optical characteristic such as a mode field diameter or a cutoff wavelength are changed. However, in the present invention, since fluorine is doped to the core, the increase in the refractive index due to the increase in concentration of Al is cancelled. As a result, it is possible to add Al with a high concentration while maintaining the adequate refractive index of the core or relative refractive index difference with the clad of the optical fiber.

### EXAMPLE

Hereinafter, the present invention will be described in detail by Examples and Comparative Examples and the present invention is not limited to Examples.

### Example 1

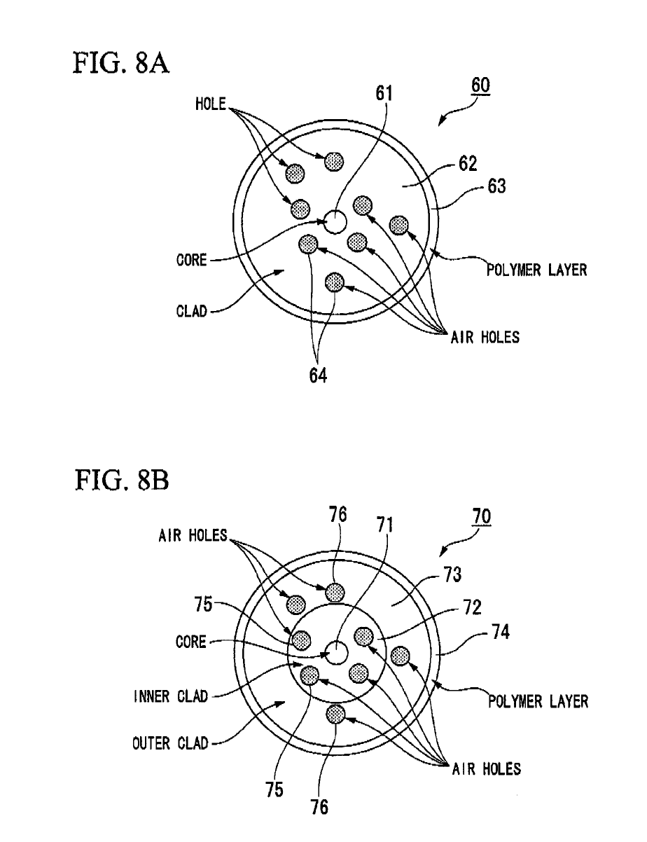

A plurality of optical fibers of which the concentrations of Al and Yb contained in a core are different was prepared as an Yb doped core double clad optical fiber having the structure shown in FIG. 9.

The diameter of the clad of the prepared Yb doped core optical fibers was 125 μm, the outer diameter of the polymer layer was 175 the diameter of the core was equal to or more than 5 μm and equal to or less than 11 μm according to the concentration of Al, and the concentrations of Al contained in the core included four kinds of 0% by mass, 1% by mass, 2% by mass and 3% by mass. In all the optical fibers, a material having a refractive index lower than that of the clad was used as the polymer layer. In detail, a fluorinated acrylic resin composition was used. The refractive index of the polymer layer was set to about 1.38. Furthermore, a plurality of these Yb-doped core optical fibers having different Yb concentrations were prepared, and the amount of the peak absorption coefficient is varied within a range of from 100 dB/m to 1500 dB/m in the absorption band which appears around a wavelength of 976 nm caused by the Yb.

Evaluation of the characteristics of decrease in the power of the laser oscillation light of the prepared Yb-doped core optical fiber was conducted with reference to “Measurement System of Photodarkening” in Non-Patent Document 2. As described above, it is thought that the decreased in the power of the laser oscillation light is caused from the loss increase by photodarkening. When the pump light at a wavelength of 976 nm is entered with a high power onto the Yb-doped core optical fiber, photodarkening occurs, thereby leading to loss. By measuring the loss at a certain wavelength after the pump light at a wavelength of 976 nm was entered for a certain period of time, the magnitude of the increase in the loss by photodarkening in the optical fiber to be measured can be measured, and it is related to the decrease rate of the light at a laser oscillation wavelength of 1060 nm. Accordingly, the characteristics of decrease in the power of laser oscillation light of the Yb-doped core optical fiber can be evaluated.

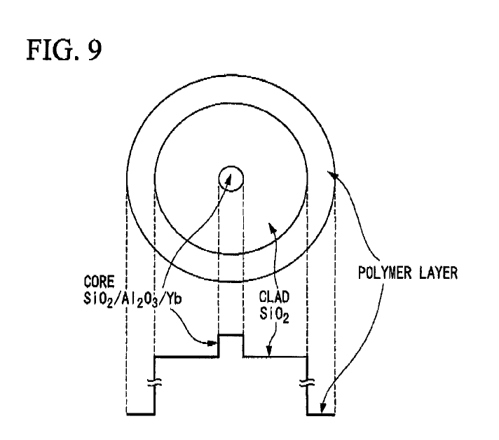

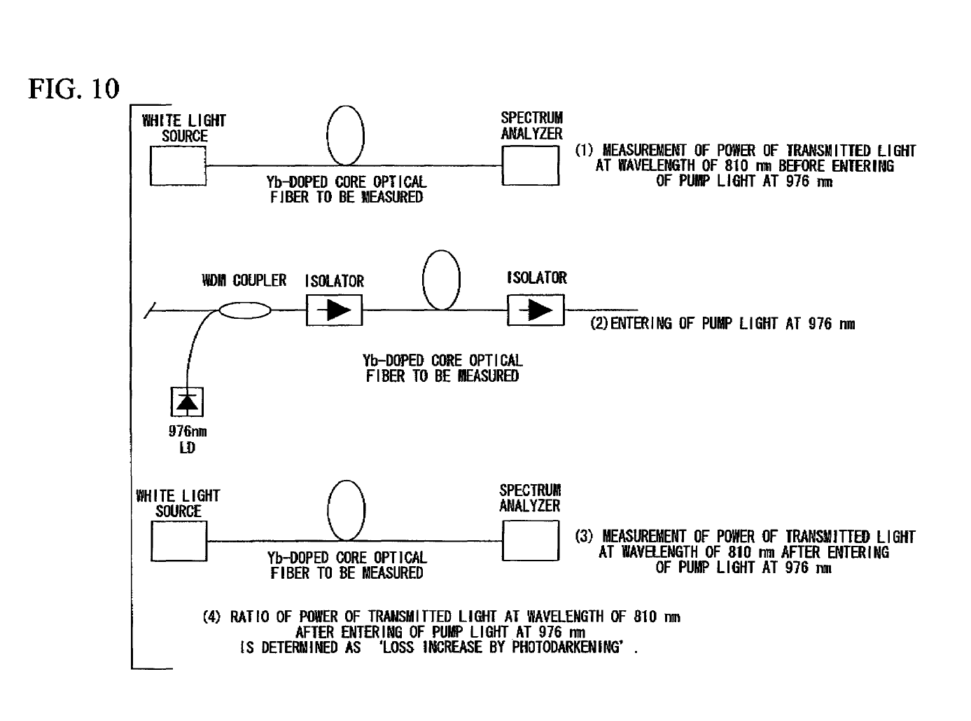

The prepared Yb-doped core optical fiber was set in a measurement instrument for measuring the loss increase by photodarkening as shown in FIG. 10, and measured. Here, the length of a sample was adjusted under a measurement condition that the peak absorption coefficient of the optical fiber to be measured at a wavelength of around 976 nm (unit: dB/m)×the length of the sample (unit: m)=340 dB, and the light power of the pump light at a wavelength of 976 nm was set a 400 mW. The loss increase by photodarkening at a wavelength of 810 nm after entering the pump light for 100 min was measured. The measurement results are shown in FIG. 11A and FIG. 11B.

As shown in FIG. 11A and FIG. 11B, it can be seen that as the absorption coefficient per unit length is higher, that is, as the Yb concentration of the optical fiber core portion is higher, the loss increase by photodarkening at a wavelength of 810 nm is higher. Furthermore, as the Al concentration of the optical fiber core portion is higher, the loss increase by photodarkening at a wavelength of 810 nm is lower.

Next, optical fiber lasers were configured using the Yb doped core optical fibers, the output power of the laser at the wavelength of 1,060 nm was measured for a long period of time.

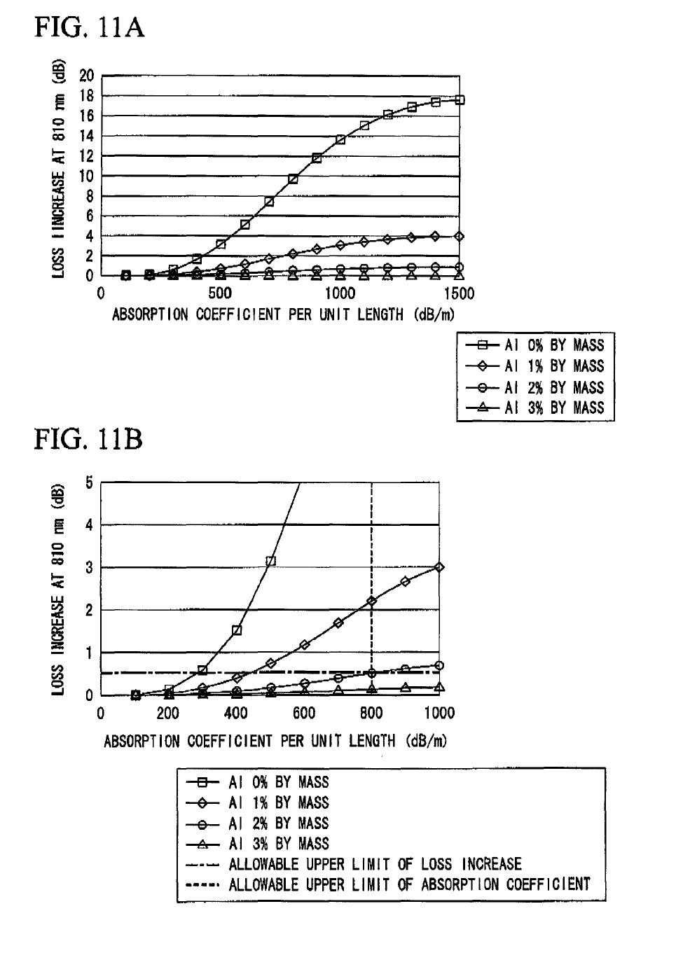

FIG. 12 shows the configuration of an optical fiber laser. This optical fiber laser includes an pump LD, a fiber grating A, an Yb-doped core optical fiber, and a fiber grating B.

The Yb doped core optical fiber was a double clad optical fiber having a core, a clad and a polymer layer and the Yb doped core optical fiber of the present invention was used.

For comparison, the conventional Yb doped core optical fiber was also used.

The concentration of Al contained in the core, the amount of the peak absorption of the light absorption band in the vicinity of the wavelength of 976 nm caused by Yb, and the amount of the loss increase by photodarkening at the wavelength of 810 nm of each of the Yb doped core optical fiber of the present invention and the conventional Yb doped core optical fiber is shown in Table 2.

TABLE 2
Yb Adding Core Optical Fiber Used in
Optical Fiber Laser of Example 1

| | | Amount of | Amount of the loss |
|---|---|---|---|
| Type of Yb doped | | the peak | increase by |
| core optical fiber | Al concentration | absorption | photodarkening |
| Present invention 1 | 2 | 800 | 0.5 |
| Present invention 2 | 2 | 450 | 0.1 |
| Conventional | 1.8 | 1,500 | 0.1 |
| product | | | |
| | % by mass | dB/m | dB |

The diameter of the core of the Yb-doped core optical fiber was 7.5 μm, the diameter of the clad was 125 μm, and the outer diameter of the polymer layer was 175 μm. A material having a refractive index lower than that of the clad was used as the polymer layer and the refractive index thereof was set to about 1.38. The relative refractive index difference Δ between the core and the clad was 0.23% in the present invention product 1 and the present invention product 2 of Table 2 and was 0.21% in the conventional product.

As can be seen from FIG. 11B, in the Yb-doped core optical fiber of the present invention product, since Al concentration is 2% by mass and the peak absorption coefficient is equal to or less than 800 dB/m or, the loss increase by photodarkening was 0.5 dB or less. In contrast, in the conventional product, since Al concentration is smaller than 2% by mass and the peak absorption coefficient is equal to or more than 800 dB/m, the loss increase by photodarkening exceeds 0.5 dB.

The fiber grating A is also constituted of an optical fiber, and the optical fiber is a double clad optical fiber having a core, a clad and a polymer layer.

A material doped to the core was only germanium (Ge), and the concentration of Ge was adjusted such that the relative refractive index difference Δ between the core and the clad becomes 0.23%. The diameter of the core was 7.5 μm, the diameter of the clad was 125 μm, and the outer diameter of the polymer layer was 175 μm. A material having a refractive index lower than that of the clad was used as the polymer layer and the refractive index thereof was set to about 1.38. The reflectivity of the fiber grating A at a reflection wavelength of 1,060 nm was substantially set to 100%.

The fiber grating B is also constituted of an optical fiber, and the optical fiber is a single mode optical fiber having a core, a clad and a protective cover layer provided on the outer circumference of the clad and having a high refractive index.

A material doped to the core was only germanium (Ge), and the concentration of Ge was adjusted such that the relative refractive index difference A between the core and the clad becomes 0.23%. The diameter of the core was 7.5 μm, the diameter of the clad was 125 μm, and the outer diameter of the polymer layer was 250 μm. The reflectivity of the fiber grating B at a reflection wavelength of 1,060 nm was substantially set to 10%.

Pump light at a wavelength of 976 nm was incident from the pump LD to the Yb-doped core optical fiber through the fiber grating A. At this time, the pump power at the wavelength of 976 nm was 13 W.

As a result of an incident of the pump light, the laser output at the wavelength of 1,060 nm was output from the optical fiber laser.

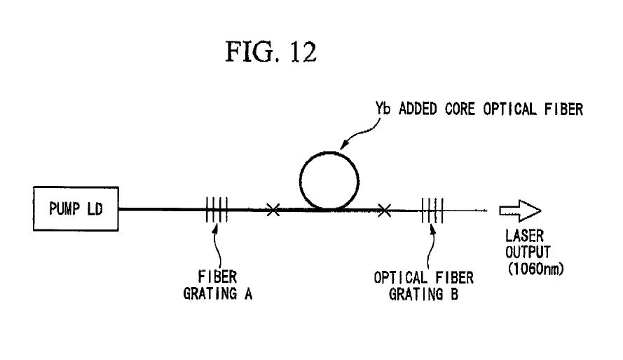

The optical fiber laser was laser-oscillated for a long time and a variation in output power of the light having the laser oscillation wavelength of 1,060 nm with time was measured. The result is shown in Table 3 and FIG. 13.

TABLE 3
Variation in Output Power of Light at
Wavelength of 1060 nm over time

| | Elapsed time | | |
|---|---|---|---|
| | (hour) | | |
| | 1 | 100 | 1000 |
| Output power (W) of the fiber of | 8.0 | 7.8 | 7.8 |
| present invention 1 | | | |
| Light output power (W) of | 8.0 | 7.5 | 7.8 |
| present invention 2 | | | |
| Light output power (W) of | 8.0 | 6.6 | 6.0 |
| conventional product | | | |

The optical fiber laser constituted by using the Yb-doped core optical fiber having a loss increase by photodarkening at a wavelength of 810 nm of 0.5 dB or less, the output power of the light at a laser oscillation wavelength of 1060 nm was not substantially reduced even when laser oscillation was carried out over a long period of time. On the other hand, the optical fiber laser constituted by using the Yb-doped core optical fiber having a loss increase by photodarkening at a wavelength of 810 nm of more than 0.5 dB, the output power of the light at a laser oscillation wavelength of 1060 nm was observed to be decreased over time. Furthermore, as the loss increase by photodarkening was higher, the decrease rate of the output power of the light at a laser oscillation wavelength of 1060 nm was higher.

From Table 3 and FIG. 13, it is expected that the output power of the light of the laser oscillation wavelength of 1,060 nm after 30,000 hours was 7.7 W in the optical fiber laser using the Yb-doped core optical fiber of the present invention product 1, was 7.1 W in the optical fiber laser using the present invention product 2, and was 5.1 W in the optical fiber laser using the conventional product. In the optical fiber laser using the present invention product, it can be seen that, even when laser oscillation is performed for a long time of 30,000 hours, the output decrease is only equal to or less than 10% when the initial output power of the light of the laser oscillation wavelength of 1,060 nm is 8 W.

As clearly shown from FIG. 11B, by constituting the Yb-doped core optical fiber such that the core had an Al concentration of 2% by mass or more, and Yb was contained at such a concentration that a absorption band which appeared around a wavelength of 976 nm showed a peak absorption coefficient of 800 dB/m or less in the absorption band by Yb contained in the core, an Yb-doped core optical fiber having a loss increase by photodarkening at a wavelength of 810 nm of 0.5 dB or less can be obtained. In addition, by using such an Yb-doped core optical fiber, even when the optical fiber laser laser-oscillates for a long time, the output of the light of the laser oscillation wavelength of 1,060 nm is hardly decreased.

### Example 2

Here, the method for deriving the inequality (A) is described.

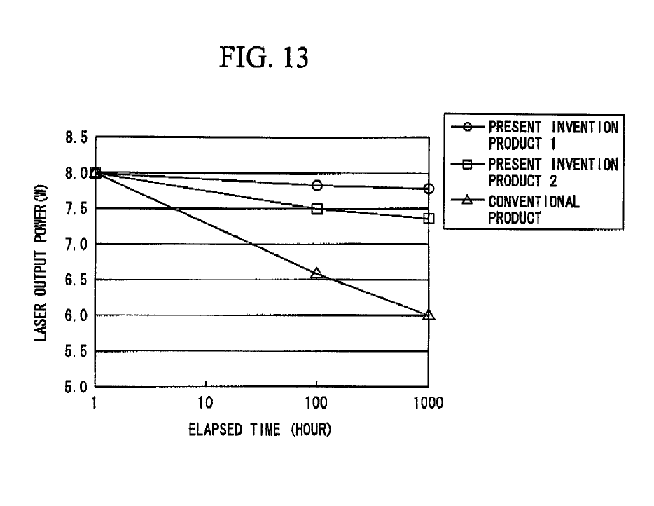

For the measurement results of the loss increase by photodarkening the Yb-doped core optical fiber in Example 1, we tried to express the relationship between the absorption coefficient and the concentration of aluminum contained in the core by an empirical equation. The data in FIG. 11A was used to determine the empirical equation. Logarithmic expression of the loss increase at 810 nm of FIG. 11A is shown in FIG. 14. The curve in FIG. 14 approximates an exponential function, and can be expressed by the following empirical equation (1).

log(L_{PD})=C₀−C₁*exp{*(−C₂*(A_{Yb})} (1)

wherein L_{PD} is a loss increase by photodarkening at a wavelength of 810 nm (unit: dB), and A_{Yb} is an absorption coefficient per unit length (unit: dB/m). C₀, C₁, and C₂ are fitting factors. For the data of each Al concentration in FIG. 14, the empirical equation (1) was used for each fitting. For best fit, the fitting factors, C₀, C₁, and C₂ were adjusted for fitting. For each Al concentration, C₀, C₁, and C₂ were determined, as shown in Table 4.

TABLE 4
Fitting factor obtained from empirical equation (1)

| | Fitting factors | | |
|---|---|---|---|
| Al concentration | C₀ | C₁ | C₂ |
| Al 0% by mass | 1.274 | 4.352 | 0.00347 |
| Al 1% by mass | 0.618 | 4.256 | 0.00337 |
| Al 2% by mass | −0.037 | 4.403 | 0.00353 |
| Al 3% by mass | −0.692 | 4.206 | 0.00335 |
| Average value | | 4.304 | 0.00343 |

As shown in Table 4, it is found that the fitting factors C₁ and C₂ give almost the same values even under different Al concentrations, whereas the fitting factor C₀ varies depending on the Al concentration. Since the fitting factors C₁ and C₂ are substantially not changed depending on the Al concentrations, the average values of C₁ and C₂ obtained from each Al concentration, C₁=4.304 and C₂=0.00343 were substituted into the empirical equation (1), thereby obtain the following empirical equation (2).

log(L_{PD})=C₀−4.304*exp{−0.00343*(A_{Yb})} (2)

It is expected that the fitting factor C₀ is variable depending on the Al concentration.

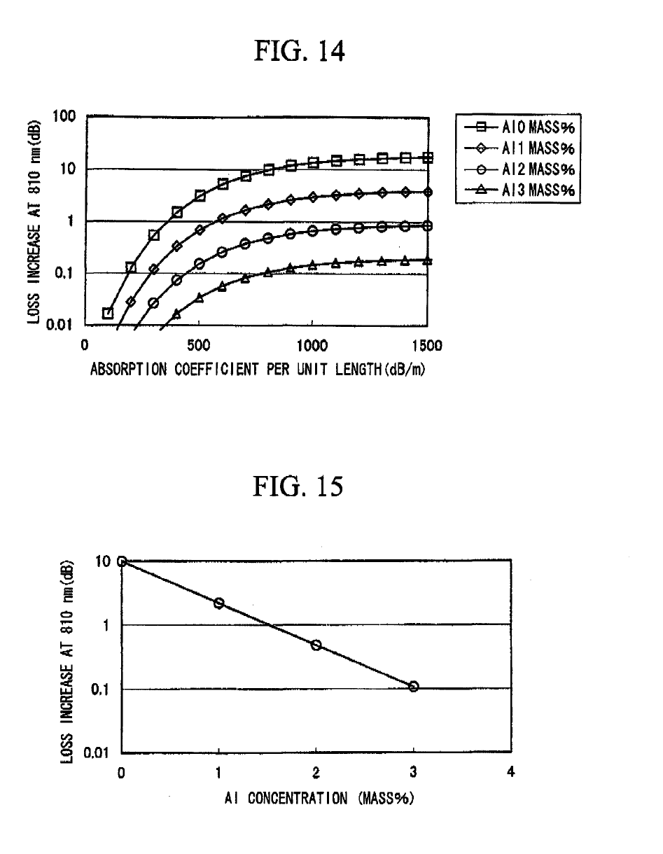

Next, in the data shown in FIG. 14, the relationship between the loss increase due to photodarkening at a wavelength of 810 nm and the Al concentrations was investigated in consideration of the absorption coefficient per unit length of 800 dB/m. FIG. 15 shows the relationship between the loss increase at 810 nm and the Al concentrations. FIG. 15 has a logarithmic expression of the loss increase at 810 nm. FIG. 15 shows the linear relationship between the logarithmic values of the loss increase at 810 nm and the Al concentrations, thereby it being expressed by the following empirical equation (3).

log(L_{PD})=−0.655*(D_{Al})+0.997 (3)

wherein D_{Al} is an Al concentration in the core (unit: % by mass).

Since the empirical equation (3) is an equation derived only from the data in a case where the absorption coefficient per unit length is 800 dB/m, 800 dB/m is substituted into A_{Yb} in the empirical equation (2), thereby obtaining the following equation (4).

log(L_{PD})=C₀−0.277 (4)

By substituting the equation (4) into the equation (3), the following equation (5) was obtained.

C₀=−0.655*(D_{Al})+1.274 (5)

By substituting the equation (5) into the equation (2), the following equation (6) was obtained.

log(L_{PD})=−0.655*(D_{Al})−4.304*exp[−0.00343*(A_{Yb})]+1.274 (6)

By modifying the equation (6), the following equation (7) was obtained.

L_{PD}=10^{{-0.655*(D}^{_{Al}}^{)-4.304*exp{-0.00343*(A}^{_{Yb}}^{)}+1.274}} (7)

Therefore, the equation (7) is an empirical equation showing the relationship between the absorption coefficients and the aluminum concentrations contained in the core, for the measurement results of the loss increase by photodarkening. If a measured value of the loss increase by photodarkening, L_{PD}, is no more than an allowable loss increase by photodarkening, T_{PD}, as described above, that is, in the case of the following inequality (8):

T_{PD}≧L_{PD} (8)

the optical fiber laser obtained using this Yb-doped core optical fiber would have good characteristics.

From the equation (7) and inequality (8), the inequality (A) is derived.

T_{PD}=10^{{-0.655*(D}^{_{Al}}^{)-4.304*exp{-0.00343*(A}^{_{Yb}}^{)}+1.274}} (A)

As shown in Example 1, the optical fiber laser constituted by using the Yb-doped core optical fiber having a loss increase by photodarkening of 0.5 dB or less, the output power of the light at a laser oscillation wavelength of 1060 nm was substantially reduced, even when laser oscillation was carried out over a long period of time. In order to obtain such the Yb-doped core optical fiber, by using the inequality (B) obtained by setting an allowable loss increase by photodarkening in the inequality (A) to T_{PD}=0.5 dB, the absorption coefficients and the aluminum concentrations should satisfy the relationship in this inequality.

0.5≧10^{{-0.655*(D}^{_{Al}}^{)-4.304*exp{-0.00343*(A}^{_{Yb}}^{)}+1.274}} (B)

To confirm the effect of the inequality (B), using the Yb-doped core optical fiber having a structure as shown in FIG. 2A, 9 kinds of fibers having different Al concentrations in the core and absorption coefficients were prepared. The Al concentration and the absorption coefficient of each fiber are shown in Table 5.

TABLE 5
List of Yb-doped core optical fibers prepared

| | | Absorption | Al | Inequality | Measured loss |
|---|---|---|---|---|---|
| Kind of | Optical | coefficient | concentration | (8) satisfied | increase at 810 nm |
| fiber | fiber | (dB/m) | (% by mass) | or not | (dB) |
| Fiber of | Sample A | 600 | 1.11 | X | 1.00 |
| Comparative | | | | | |
| Example | | | | | |
| Fiber of the | Sample B | 600 | 1.57 | ◯ | 0.50 |
| present | | | | | |
| invention | | | | | |
| Fiber of the | Sample C | 600 | 1.9 | ◯ | 0.30 |
| present | | | | | |
| invention | | | | | |
| Fiber of | Sample D | 800 | 1.52 | X | 1.00 |
| Comparative | | | | | |
| Example | | | | | |
| Fiber of the | Sample E | 800 | 1.98 | ◯ | 0.50 |
| present | | | | | |
| invention | | | | | |
| Fiber of the | Sample F | 800 | 2.32 | ◯ | 0.30 |
| present | | | | | |
| invention | | | | | |
| Fiber of | Sample G | 1000 | 1.73 | X | 1.00 |
| Comparative | | | | | |
| Example | | | | | |
| Fiber of the | Sample H | 1000 | 2.19 | ◯ | 0.50 |
| present | | | | | |
| invention | | | | | |
| Fiber of the | Sample I | 1000 | 2.53 | ◯ | 0.30 |
| present | | | | | |
| invention | | | | | |

For the samples, A, B, and C, the absorption coefficients are all 600 dB/m, but the Al concentrations are different from each other. For the samples, D, E, and F, the absorption coefficients are all 800 dB/m, but the Al concentrations are different from each other. For the samples, G, H, and I, the absorption coefficients are all 1000 dB/m, but the Al concentrations are different from each other. In Comparative Examples, if the absorption coefficient and the Al concentration of each of the samples, A, D, G are substituted into the inequality (B), the right hand side of the inequality (B) is more than 0.5 in any of the fibers, and accordingly it does not satisfy the condition of the inequality (B). On the other hand, the samples, B, C, E, F, H, and I, that are the optical fibers of the present invention, all satisfy the condition of the inequality (B).

In a similar manner to Example 1, for the Yb-doped core optical fibers of the samples A through I, the loss increase by photodarkening at a wavelength of 810 nm was measured. The results are shown in Table 5. As seen from Table 5, the samples, B, C, E, F, H, and I, that are the optical fibers of the present invention, all have a loss increase by photodarkening of 0.5 dB or less. On the other hand, the samples, A, D, and G in Comparative Examples, all had a loss increase by photodarkening of more than 0.5 dB.

As clearly seen from Table 5, by doping aluminum and ytterbium in the core such that the concentration of aluminum contained in the core, and the peak absorption coefficient of the absorption band which appears at a wavelength of 976 nm in the absorption band by ytterbium contained in the core satisfy the inequality (B), it is possible to obtain an Yb-doped core optical fiber having a loss increase by photodarkening at a wavelength of 810 nm of 0.5 dB or less.

### Example 3

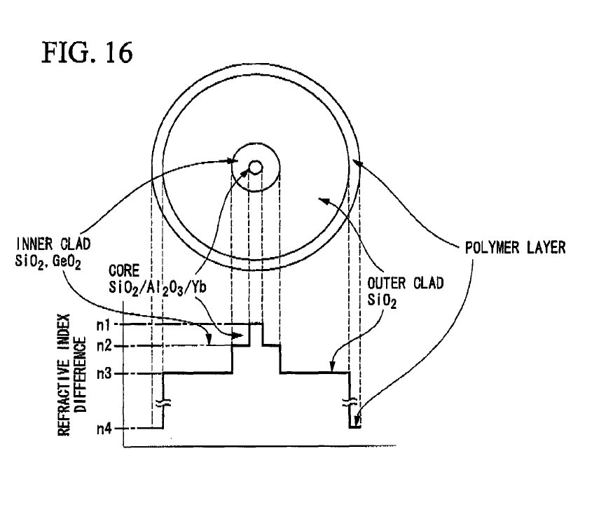

An Yb-doped core optical fiber having the structure shown in FIG. 16 was prepared.

The diameter of the core of the prepared Yb-doped core optical fiber was 20 μm, the diameter of the inner clad was 100 μm, the diameter of the outer clad was 400 μm, and the outer diameter of the polymer layer was 440 p.m. Yb and Al were doped to the core, Ge was doped to the inner clad, and little or no material was doped to the outer clad, thereby obtaining a silica glass as the outer clad. A material having a refractive index lower than that of the clad was used as the polymer layer. In detail, a fluorinated acrylic resin composition was used. The Al concentration of the core was 2.4% by mass and the peak absorption coefficient of the absorption band in the vicinity of the wavelength of 976 nm caused by the Yb concentration was 1,500 dB/m.

The refractive indices of the portions were adjusted such that the refractive index n1 of the core, the refractive index n2 of the inner clad, the refractive index n3 of the outer clad and the refractive index of the polymer layer become n1>n2>n3>n4. In detail, the refractive index n1 of the core was 1.4605, the refractive index n2 of the inner clad was 1.4591, the refractive index n3 of the outer clad was 1.4565, and the refractive index n4 of the polymer layer was 1.38.

The measured loss increase by photodarkening at the wavelength of 810 nm of the Yb-doped core optical fiber was 0.5 dB. When the mode field diameter, the effective area A_{eff}, and the cutoff wavelength are measured by guiding the light of the wavelength of 1,060 nm to the core portion of the Yb-doped core optical fiber, the mode field diameter was 17.2 μm, the effective area A_{eff} was 254 μm², and the cutoff wavelength was 1,300 nm. When the cutoff wavelength is measured again in a state in which the Yb-doped core optical fiber is bent with a diameter of 150 nm in a coil shape, the cutoff wavelength was equal to or less than 1,060 nm.

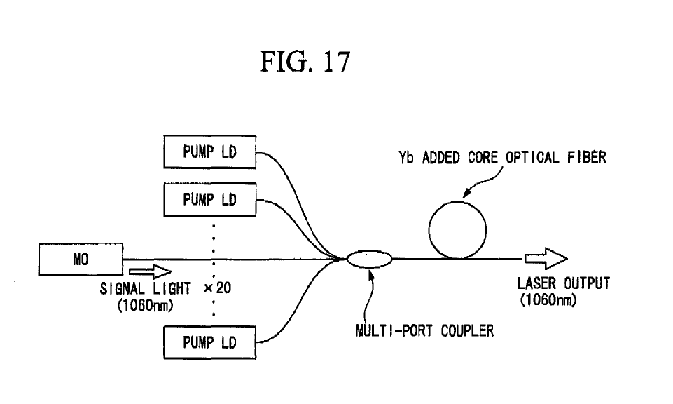

Next, an optical fiber laser shown in FIG. 17 was configured using an Yb-doped core optical fiber.

This optical fiber laser is of a Master Oscillator-Power Amplifier (MO-PA) configuration and amplifies signal light of a wavelength of 1,060 nm emitted from an MO portion using an Yb-doped core optical fiber set at an opposite side from output side so as to obtain high-output laser light. The Yb-doped core optical fiber is pumped by pump light emitted from 20 pump LDs. The pump light emitted from the pump LDs was incident to the inner clad and the outer clad of the Yb-doped core optical fiber through a multi-port coupler. The signal light of a wavelength of 1,060 nm emitted from the MO portion was incident to the core portion of the Yb-doped core optical fiber.

When the wavelength spectrum of the laser light obtained from the optical fiber laser is measured, laser output light of a central wavelength of 1,060 nm was observed. In a wavelength region longer than a wavelength of 1,060 nm, in particular, the peak of the spectrum was not observed and it means that stimulated Raman scattering does not occur in the Yb-doped core optical fiber.

### Comparative Example

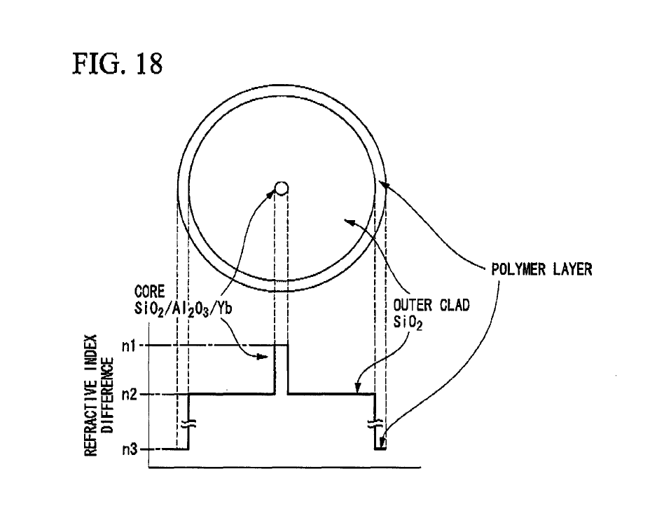

As a comparative example, an Yb-doped core optical fiber having the structure shown in FIG. 18 was prepared.

The prepared Yb-doped core optical fiber includes a core, a clad and a polymer layer. The diameter of the clad was 400 μm and the outer diameter of the polymer layer was 440 μm. Yb and Al were doped to the core and a silica glass to which little or no other material is doped was used as the clad. A material having a refractive index lower than that of the clad was used as the polymer layer. In detail, a fluorinated acrylic resin composition was used. The Al concentration of the core was 2.4% by mass and the peak absorption coefficient of the absorption band in the vicinity of the wavelength of 976 nm caused by the Yb concentration was 1500 dB/m. The refractive index n1 of the core was 1.4605, the refractive index n2 of the inner clad was 1.4565, and the refractive index n3 of the polymer layer was 1.38.

The refractive index difference nA (=n1−n2) between the core and the clad which is in contact with the core was 0.0040 in the Yb-doped core optical fiber of the comparative example. In contrast, the refractive index difference nA of the Yb-doped core optical fiber of Example 3 is a difference between the refractive index n1 of the core and the refractive index n2 of the inner clad and thus becomes 0.0015. Accordingly, the refractive index difference nA of the comparative example is more than that of Example 3. Accordingly, if the diameter of the core is set to 20 μm like the Yb-doped core optical fiber of Example 3, the cutoff wavelength of the comparative example is significantly increased comparing to the Yb-doped core optical fiber of Example 3 and is not appropriate to use in the optical fiber laser. In order to set the cutoff wavelength to be the same level to that of the optical fiber of Example 3, the diameter of the core of the Yb-doped core optical fiber of the comparative example was set to 10.3 μm. In addition, when the mode field diameter, the effective area A_{eff}, and the cutoff wavelength are measured by guiding the light of the wavelength of 1,060 nm to the core portion of the Yb-doped core optical fiber, the mode field diameter was 9.4 μm, the effective area A_{eff} was 74 μm², and the cutoff wavelength was 1,300 nm.

Similar to Example 3, when the optical fiber laser shown in FIG. 17 is configured and the wavelength spectrum of the laser light obtained from the optical fiber laser is measured, unwanted light due to stimulated Raman scattering occurs, and thus it is observed that laser light is emitted not only at a wavelength of 1,060 nm but also at a wavelength region longer than that wavelength.

### INDUSTRIAL APPLICABILITY

According to a rare earth-doped core optical fiber of the present invention, it is possible to manufacture an optical fiber laser capable of maintaining a sufficient laser oscillation output even when used for a long time, without decreasing the output of light having a laser oscillation wavelength even when laser oscillation is performed for a long period of time.

1. A rare earth-doped core optical fiber comprising a core including a silica glass containing at least aluminum and ytterbium, a clad provided around the core and comprising a silica glass having a lower refraction index than that of the core, and a polymer layer provided on the outer circumference of the clad and having a lower refractive index than that of the dad, wherein aluminum and ytterbium are doped into the core such that a loss increase by photodarkening, T_{PD}, satisfies the following inequality (A):
T_{PD}≧10^{{-0.655*(D}^{_{Al}}^{)-4.304*exp{-0.00343*(A}^{_{Yb}}^{)}+1274}} (A)
[in inequality (A), TPD represents an allowable loss increase by photodarkening at a wavelength of 810 nm (unit: dB), D_{Al} represents the concentration of aluminum contained in the core (unit: % by mass), and A_{Yb} represents the peak absorption coefficient of the absorption band which appears around a wavelength of 976 nm in the absorption band by ytterbium contained in the core (unit: dB/m)].

2. A rare earth-doped core optical fiber comprising a core comprising a silica glass containing aluminum and ytterbium, a clad provided around the core and comprising a silica glass having a lower refraction index than that of the core, and a polymer layer provided on the outer circumference of the clad and having a lower refractive index than that of the clad, wherein the core has an aluminum concentration of 2% by mass or more, and ytterbium is doped into the core at such a concentration that the absorption band of ytterbium doped into the core, which appears around a wavelength of 976 nm, shows a peak absorption coefficient of 800 dB/m or less.

3. The rare earth-doped core optical fiber according to claim 1 or 2, wherein the clad is composed of an inner clad positioned on the exterior of the core, and an outer clad positioned outside the inner clad, and that the refractive index n1 of the core, the refractive index n2 of the inner clad, the refractive index n3 of the outer clad, and the refractive index n4 of the polymer layer satisfy the relationship of n1>n2>n3>n4.

4. The rare earth-doped core optical fiber according to claim 1 or 2, wherein the shape of the outer circumference of the clad which is in contact with the polymer layer is non-circular.

5. The rare earth-doped core optical fiber according to claim 4, wherein the shape of the outer circumference of the clad which is in contact with the polymer layer is one selected from a group consisting of a hexagon, a heptagon, an octagon, a nonagon, a D-type.

6. The rare earth-doped core optical fiber according to claim 1 or 2, wherein air holes are present in a part of the clad glass.

7. The rare earth-doped core optical fiber according to claim 1 or 2, wherein the core contains fluorine.
